(19) United States
(12) Patent Application Publication
(10) Pub. No.: US 2015/0106394 A1
(43) Pub. Date: Apr. 16, 2015

(54) AUTOMATICALLY PLAYING AUDIO ANNOUNCEMENTS IN MUSIC PLAYER

(71) Applicant: Google Inc., Mountain View, CA (US)

(72) Inventors: Owen Daniel Otto, Berkeley, CA (US); Brandon Bilinski, San Francisco, CA (US)

(73) Assignee: Google Inc., Mountain View, CA (US)

(21) Appl. No.: 14/055,715

(22) Filed: Oct. 16, 2013

(51) Int. Cl. G06F 17/30

(52) U.S. Cl. CPC G06F 17/30746
USPC 707/758

(57) ABSTRACT

A method, which is executed by a processor, includes receiving a request to access music from a user account. The music is to be streamed to a device from which the user account has generated the request. The method further includes streaming music to the device for rendering, and automatically inserting descriptive voice-audio data into the stream for rendering. The descriptive voice-audio data includes information regarding the music, for example, the artist name and song title.

### BACKGROUND

Music streaming services enable users to listen to new and unfamiliar songs for music discovery. When a user discovers a new song that she likes, the user typically wants to know the name of the artist and the title of the song. In many cases, however, it is inconvenient or unsafe for the user to look at a display, e.g., the screen of a smartphone, to ascertain this information. For example, the user could be using the smartphone to listen to music while driving a car, jogging, or working out at a gym.

It is in this context that embodiments arise.

### SUMMARY

In an example embodiment, a method, which is executed by one or more processors, includes receiving a request to access audio data from a user account. The audio data includes a plurality of songs to be streamed to a device from which the user account generated the request. The method also includes identifying a first song of the plurality of songs to be streamed to the device, and identifying an audio snippet for the first song. The audio snippet includes descriptive voice-audio data regarding the first song. The method further includes streaming the first song and the audio snippet to the device for rendering. The audio snippet is streamed before a second song of the plurality of songs is streamed to the device for rendering.

In one embodiment, the identifying of the audio snippet for the first song includes accessing a music repository that includes a database of songs, with the first song being included in the database of songs and being associated with an audio snippet. In this embodiment, the audio snippet is a prerecorded audio file.

In another embodiment, the identifying of the audio snippet for the first song includes examining metadata for the first song, identifying preferences associated with the user account, generating the audio snippet using at least a part of the metadata for the first song, and associating the audio snippet with the first song. In one example, the generating of the audio snippet includes performing text-to-voice processing on at least a part of the metadata for the first song.

In one embodiment, the method further includes processing insertion logic to determine a placement of the audio snippet relative to the first song. The placement might be before, after, or during the first song. The insertion logic provides for a transition between the first song and the audio snippet.

In one embodiment, the placement of the audio snippet is during the first song, and the insertion logic provides for the transition by causing a volume at which the first song is being rendered to be lowered. In one embodiment, the descriptive voice-audio data introduces the first song or closes out the first song. In one embodiment, the descriptive voice-audio data includes an artist name and a song title.

In another example embodiment, a method, which is executed by one or more processors, includes receiving a request to access a playlist from a user account. The playlist includes a plurality of songs to be streamed to a device from which the user account generated the request. The method also includes identifying a song in the playlist to be streamed to the device, and accessing an audio snippet associated with the song, with the audio snippet being descriptive voice-audio data regarding the song. The method further includes streaming the song and the audio snippet to the device for rendering. The audio snippet is streamed before another song in the playlist is streamed to the device for rendering.

In one embodiment, the audio snippet associated with the song is a prerecorded audio file. In one embodiment, the audio snippet associated with the song is generated by performing text-to-voice processing on at least part of the metadata for the song. In one embodiment, the audio snippet introduces the song by providing an artist name and a song title. In one embodiment, the audio snippet closes out the song by providing an artist name and a song title.

In yet another example embodiment, a method, which is executed by one or more processors, includes receiving a request to access music from a user account. The music is to be streamed to the device from which the user account generated the request. The method also includes streaming music to the device for rendering, and automatically inserting descriptive voice-audio data into the stream for rendering. The descriptive voice-audio data includes information regarding the music.

In one embodiment, the automatic insertion of the descriptive voice-audio data into the stream for rendering includes receiving a voice command from the user account for information regarding a song, accessing a prerecorded audio file associated with the song, and inserting the prerecorded audio file into the stream for rendering.

In one embodiment, the automatic insertion of the descriptive voice-audio data into the stream for rendering includes receiving a voice command from the user account for information regarding a song, examining metadata for the song, performing text-to-voice processing on at least a part of the metadata for the song to generate an audio file containing descriptive voice-audio data and associating the audio file with the song, and inserting the audio file into the stream for rendering.

In one embodiment, the descriptive-voice audio data is inserted into the stream so as to introduce a song. In one embodiment, the descriptive-voice audio data is inserted into the stream so as to close out a song. In one embodiment, the descriptive voice-audio data includes an artist name and a song title.

In still another example embodiment, a non-transitory computer-readable storage device is provided. The computer-readable storage device stores a program which, when executed, instructs a processor to receive a request to access music from a user account, with the music to be streamed to a device from which the user account generated the request, stream music to the device for rendering, and automatically insert descriptive voice-audio data into the stream for rendering, with the descriptive voice-audio data including information regarding the music.

In one embodiment, in connection with the automatic insertion of the descriptive voice-audio data into the stream for rendering, the program further instructs the processor to receive a voice command from the user account for information regarding a song, access a prerecorded audio file associated with the song, and insert the prerecorded audio file into the stream for rendering.

In one embodiment, in connection with the automatic insertion of the descriptive voice-audio data into the stream for rendering, the program further instructs the processor to receive a voice command from the user account for information regarding a song, examine metadata for the song, perform text-to-voice processing on at least a part of the metadata for the song to generate an audio file containing descriptive voice-audio and associate the audio file with the song, and insert the audio file into the stream for rendering.

In one embodiment, the descriptive-voice audio data is inserted into the stream so as to introduce a song. In one embodiment, the descriptive-voice audio data is inserted into the stream so as to close out a song. In one embodiment, the descriptive voice-audio data includes an artist name and a song title.

Other aspects and advantages of the disclosures herein will become apparent from the following detailed description, taken in conjunction with the accompanying drawings, which illustrate by way of example the principles of the disclosures.

### BRIEF DESCRIPTION OF THE DRAWINGS

FIG. 1 is a diagram that shows a simplified overview of a music streaming system that automatically plays audio announcements, in accordance with an example embodiment.

FIG. 2A is a diagram that illustrates an example of the queue streamed by a streaming service and the queue of songs that is displayed on the screen of client device, in accordance with an example embodiment.

FIG. 2B is a diagram that illustrates another example of the queue streamed by a streaming service and the queue of songs that is displayed on the screen of client device.

FIG. 3 is a diagram that shows additional details of a music streaming system that automatically plays audio announcements, in accordance with an example embodiment.

FIG. 4 is a flowchart diagram illustrating the method operations performed in automatically playing audio announcements in a music stream, in accordance with an example embodiment.

FIG. 5 is a flowchart diagram illustrating in more detail the method operations performed in connection with the identification of an audio snippet to be associated with the first song, in accordance with an example embodiment.

FIG. 6 is a flowchart diagram illustrating the method operations performed in providing automated audio announcements in streaming music, in accordance with an example embodiment.

### DETAILED DESCRIPTION

In the following description, numerous specific details are set forth in order to provide a thorough understanding of the example embodiments. However, it will be apparent to one skilled in the art that the example embodiments may be practiced without some of these specific details. In other instances, process operations and implementation details have not been described in detail, if already well known.

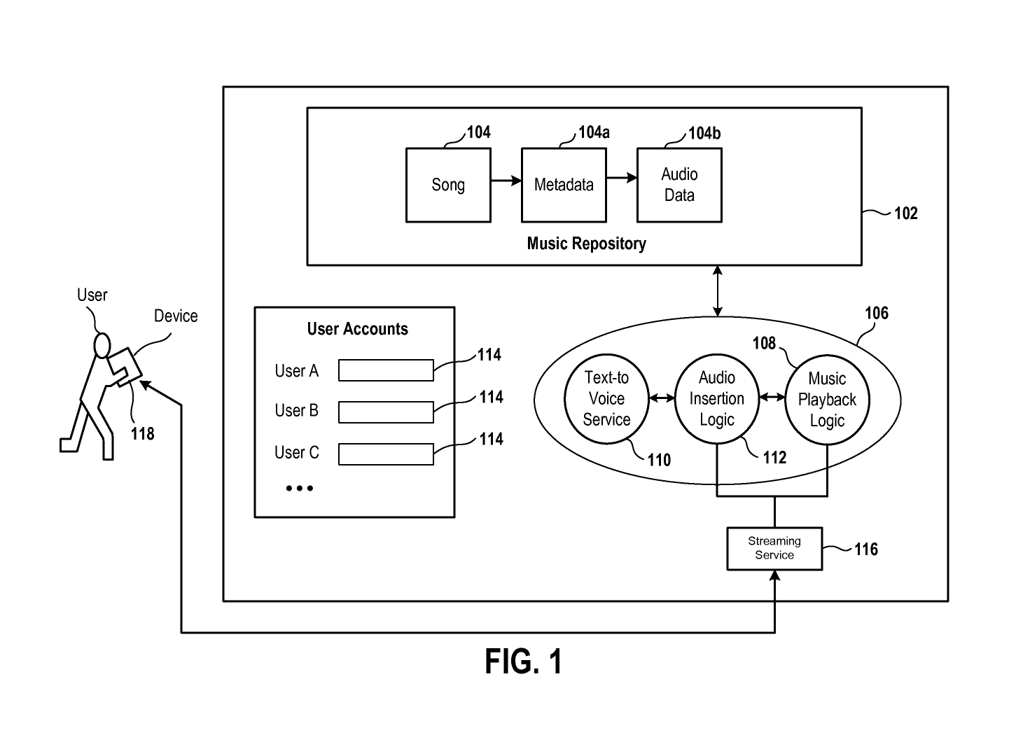

FIG. 1 is a diagram that shows a simplified overview of a music streaming system that automatically plays audio announcements, in accordance with an example embodiment. As shown in FIG. 1, music streaming system 100 includes music repository 102, which includes the songs available for streaming. Each song file 104 includes metadata 104a and audio data 104b. The metadata 104a includes information regarding the song, e.g., the name of the artist, the name of the song, the name of the album, the track number, the genre, etc. The audio data 104b can be in any suitable format, e.g., mp3, aac, m4a, flac, ogg, etc. In one example embodiment, the metadata 104a is contained in an ID3 tag and the audio data 104b is in mp3 format.

The music streaming system 100 further includes music servers 106, which are provided with music playback logic 108, audio insertion logic 110, text-to-voice service 112, as well as other servers and services. The music playback logic 108 determines which songs from music repository 102 are to be played based on input from a user and generates a queue of songs for playback. For example, if the user has selected the category “jazz” for playback in “radio mode,” then the music playback logic 108 generates a queue of “jazz” songs from the music repository 102 for playback. In one implementation, the text-to-voice service 110 generates audio snippets for each song using the metadata 104a in each song file 104. In other implementations, the audio snippets can be prerecorded audio files that are selected for use based on, among other things, the preferences of the user. The audio insertion logic 112 inserts the audio snippets into the queue of songs generated by the music playback logic 108, as will be explained in more detail below. The amount of the metadata information included in the audio snippet can be varied based on the preferences 114 in each user account. For example, some users might prefer that the audio snippet include only the basic information, e.g., artist name and song title. Other users might prefer that the audio snippet include more extensive information, e.g., artist name, song title, album name, and anecdote(s) regarding the artist and/or the song (when available).

Streaming service 116 streams the queue of songs to be played and the audio snippets that have been inserted into the queue to a client device 118 over a network, e.g., a wide area network (WAN) such as the Internet. The client device 118 might be any mobile computing device, e.g., a smartphone or tablet computer. Alternatively, client device 118 might be a relatively non-mobile computing device, e.g., a desktop computer, a laptop computer, or any computing device with a connection to the Internet.

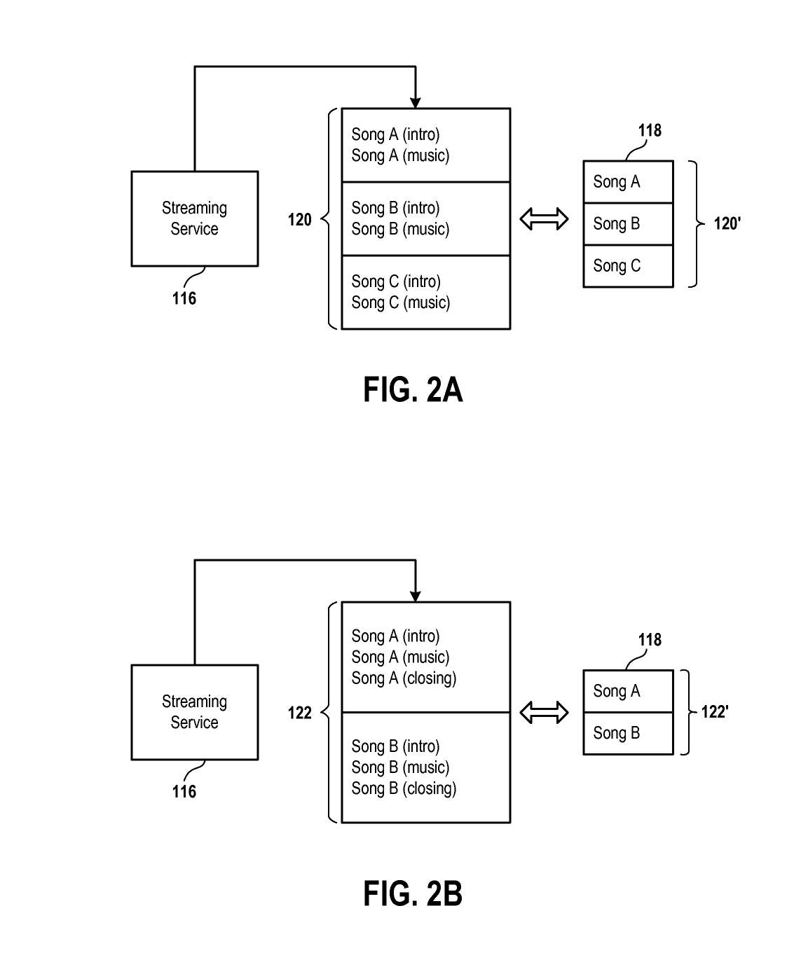

FIG. 2A is a diagram that illustrates an example of the queue streamed by streaming service 116 and the queue of songs that is displayed on the screen of client device 118. As shown in FIG. 2A, the queue 120 being streamed by steaming service 116 includes song A (intro), song A (music), song B (intro), song B (music), song C (intro), and song C (music). In this embodiment, the “intro” for each of songs A-C is the audio snippet generated by the text-to-voice service 110 using the metadata 104a for each song. The “music” for each of songs A-C is the audio data 104b contained in each song file 104. The queue 120′ is the queue of songs that is displayed on the screen of client device 118. As shown in FIG. 2A, the queue 120′ includes only songs A-C. In other words, the “intro” for each of songs A-C is not made visible to the user on the client device. In other embodiments, the “intro” can be a prerecorded audio file that does not need to be converted from text to voice. In such a case, a reference can be made in the queue being streamed by the streaming device to audio files stored in a database.

FIG. 2B is a diagram that illustrates another example of the queue streamed by streaming service 116 and the queue of songs that is displayed on the screen of client device 118. As shown in FIG. 2B, the queue 122 being streamed by steaming service 116 includes song A (intro), song A (music), song A (closing), song B (intro), song B (music), and song B (closing). In this embodiment, the “intro” and the “closing” for each of songs A and B are audio snippets generated by the text-to-voice service 110 using the metadata 104a for each song. The “music” for each of songs A and B is the audio data 104b contained in each song file 104. The queue 122′ is the queue of songs that is displayed on the screen of client device 118. As shown in FIG. 2B, the queue 122′ includes only songs A and B. In other words, the “intro” and the “closing” for each of songs A and B are not made visible to the user on the client device. In other embodiments, the “intro” and/or the “closing” can be a prerecorded audio file that does not need to be converted from text to voice. In such a case, a reference can be made in the queue being streamed by the streaming device to audio files stored in a database.

The format of the audio snippets used to introduce or close out songs can be varied to suit the needs of the queues in which they are used. In the case of a queue in which only song introductions are used (see FIG. 2A), the audio snippet might introduce a song as follows: “Up next [song title] by [artist].” For example, “Up next “Satisfaction” by the Rolling Stones.” In the case of a queue in which both song introductions and song closings are used (see FIG. 2B), the audio snippet might close out a song as follows: “That was [song title] by [artist].” For example, “That was “Satisfaction” by the Rolling Stones.”

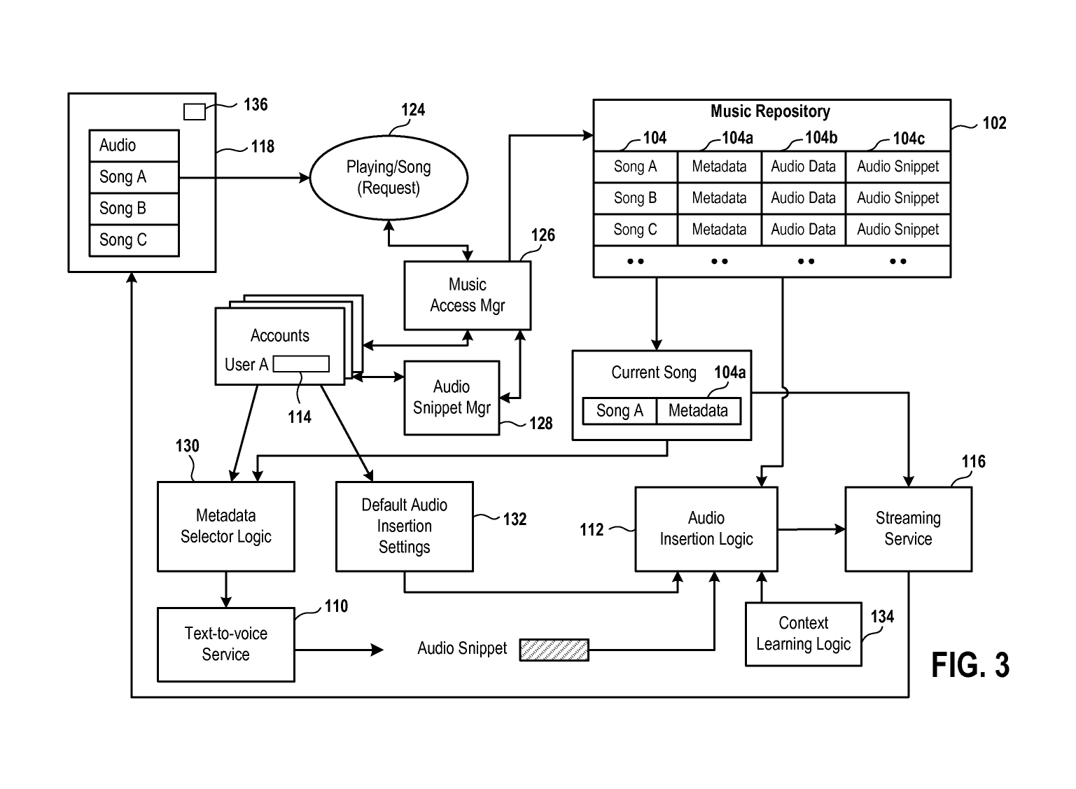

FIG. 3 is a diagram that shows additional details of a music streaming system that automatically plays audio announcements, in accordance with an example embodiment. As shown in FIG. 3, when client device 118 issues a request 124 for playback of a playlist/song, the request is passed to music access manager 126 and audio snippet manager 128 for processing. The music access manager 126 checks the user accounts to determine whether the user from which the request was received, e.g., user A, is entitled to access to the requested playlist/song. The audio snippet manager 128 checks the preferences 114 of the user to determine what type of audio snippet, e.g., text-to-voice generated or prerecorded audio file, should be used in connection with the requested playlist/song. In the absence of user preferences, default audio insertion settings 132 can be used to determine the type of audio snippet to be used, as well as the manner in which the audio snippet is inserted into the streaming music. Once access is granted, the request 124 is passed to music repository 102 for further processing.

The music repository 102 responds to the request 124 by providing access to the requested song 104, e.g., Song A, and this song is referred to as the “current song.” At this point, further processing of the current song depends on the type of audio snippet to be used in connection with this song. If a text-to-voice generated audio snippet is to be used, then the metadata 104a associated with the current song is processed by metadata selector logic 130. Based on either the preferences 114 of the user or the default settings, the metadata selector logic 130 selects the metadata 104a, e.g., artist name and song title, to be used to generate the audio snippet. The selected metadata is processed by text-to-voice service 110 to generate the audio snippet, which is stored in an audio file format, e.g., mp3.

If a prerecorded audio file is to be used as the audio snippet, then an audio snippet 104c associated with the current song, e.g., song A, is selected for use based on either the preferences 114 of the user or the default settings. The prerecorded audio file can be prepared by having a person read the desired information about the song, e.g., artist name and song title, and associating the audio file with the song in a database. In one example, the person reading the information about the song is a professional announcer. In another example, the person reading the information about the song is the user herself. In yet another example, the person reading the information about the song is a celebrity, e.g., the artist performing the song or a well-known actor/actress.

The audio insertion logic 112 inserts the audio snippets into the queue of songs being streamed by streaming service 116. In one example, before playback of a song, the audio insertion logic 112 stops playback of the queue to provide a transition between a song and the audio snippet. After a brief pause, e.g., one to two seconds, the audio insertion logic 112 causes an audio snippet introducing the song to be played. The audio snippet can be either a text-to-voice generated audio snippet produced in real time or a prerecorded audio file. After another brief pause, e.g., one to two seconds, the audio insertion logic 112 causes playback of the queue of songs to resume. In another example, at the conclusion of a song, the audio insertion logic stops playback of the queue. After a brief pause, the audio insertion logic 112 causes an audio snippet closing out the song to be played. After another brief pause, the audio insertion logic 112 causes playback of the queue of songs to resume.

It will be appreciated that the manner in which the song announcements are made can be varied to make the system more playful. In one example, the song information might be announced before and after each song. For example, the audio snippet might say the following: “That was “Billie Jean” by Michael Jackson. Up next is “Satisfaction” by the Rolling Stones.” In another example, instead of playing an audio snippet during a pause between songs, the audio insertion logic 112 could fade in the audio snippet, e.g., by causing the volume of the song being played to be lowered and playing the audio snippet over the song being played back. After the audio snippet has been played, the audio insertion logic could cause the volume to be increased back to the original level.

With continuing reference to FIG. 3, context learning logic 134 determines preferences of the user regarding audio snippets as the queue of songs is played by streaming service 116. For example, if a user repeatedly requests that an audio snippet be used to introduce “country” songs, the context learning logic 134 will learn to automatically provide the user with introductory audio snippets whenever a “country” song is played, e.g., “Up next is “See You Again” by Carrie Underwood.” On the other hand, if a user repeatedly requests that an audio snippet be used to close out “jazz” songs, the context learning logic will learn to automatically provide the user with closing audio snippets whenever a “jazz” song is played, e.g., “That was “Feeling Good” by Nina Simone.” To implement the playing of the audio snippets at the desired times, the context learning logic 134 can send appropriate instructions to the audio insertion logic 112.

The context learning logic 134 also can function to instruct audio insertion logic 112 regarding the insertion of audio snippets based on the music being streamed by streaming service 116. For example, consider the case of a user streaming an album, e.g., “Who's Next” by The Who. In this context, the user would typically not want audio snippets to be inserted because the user is most likely already familiar with the songs on the album. Accordingly, context learning logic 134 would instruct audio insertion logic 112 not to insert any audio snippets during the streaming of the songs on the album. On the other hand, consider the case of a user streaming a curated playlist. In this context, the user would typically want detailed audio snippets to be inserted because the user is most likely not at all familiar with the songs being played. Accordingly, context learning logic 134 would instruct audio insertion logic 112 to insert detailed audio snippets during the streaming of the songs in the curated playlist.

Streaming service 116 streams the queue of songs to be played and the audio snippets that have been inserted into the queue to a client device 118 over a network. Although the “actual” queue includes the audio snippets associated with each song, the queue that is visible to the user on the display of client device 118 includes only the songs in the queue, e.g., song A, song B, song C, etc. In the event the user deletes one of the songs from the queue, the audio snippets associated with that song are automatically deleted from the “actual” queue so that they will not be played.

In one example implementation, the user can request song information on an on-demand basis using a voice command. For example, a listener 136 can be provided in client device 118. The listener 136 can be any suitable listening device, e.g., a microphone coupled to audio processing circuitry. In one example, listener 136 is constantly running and listens for the user say the command “What song is this?” To facilitate this process, the user can train the listener 136 to recognize her voice in a training process, as is well known in the art of voice recognition. In another example, listener 136 can be activated when the user presses a button on the client device 118. The button might be either a physical button on the client device 118 or a graphical user interface (GUI) widget on a display of the client device. When the listener 136 hears the user say the phrase “What song is this?,” the system announces the basic song information, e.g., artist name and song title. The audio snippet used for such on-demand announcement can be either a text-to-voice generated audio snippet produced in real time or a prerecorded audio file. In one example, the system might lower the playback volume and make the automated announcement as the song plays at the reduced volume. In another example, the system might pause the playback of the song and make the automated announcement. Once the automated announcement has been made, the system would either increase the playback volume of the song to the original level or resume playback of the song.

It will be appreciated that different mappings can be used to provide additional information to the user on an on-demand basis. For example, when the listener 136 hears the user say the phrase “Tell me more about this song,” the system might announce more detailed information about the song generated from the metadata for the song or available in a prerecorded audio file associated with the song. The more detailed information about the song can include any available information about the song beyond the basic information, e.g., artist name and song title, provided in response to the phrase “What song is this?”

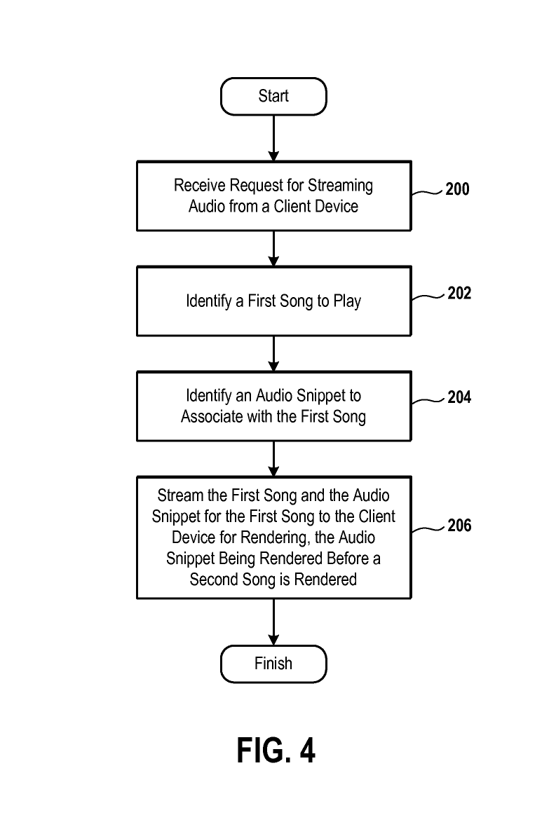

FIG. 4 is a flowchart diagram illustrating the method operations performed in automatically playing audio announcements in a music stream, in accordance with an example embodiment. In operation 200, a request for streaming audio is received from a client device, e.g., a smartphone, a tablet computer, or other computing device. In operation 202, the first song to be played in the playlist is identified. In operation 204, an audio snippet to be associated with the first song is identified. By way of example, the audio snippet might be either a text-to-voice generated audio snippet produced in real time or a prerecorded audio file. In operation 206, the first song and the audio snippet associated with the first song are streamed to the client device for rendering. In one example, the audio snippet is rendered by the client device before a second song is rendered. For example, the audio snippet can be rendered before the first song is played, during the playback of the first song, e.g., by fading in the audio snippet as playback of the first song begins, or immediately after playback of the first song has finished.

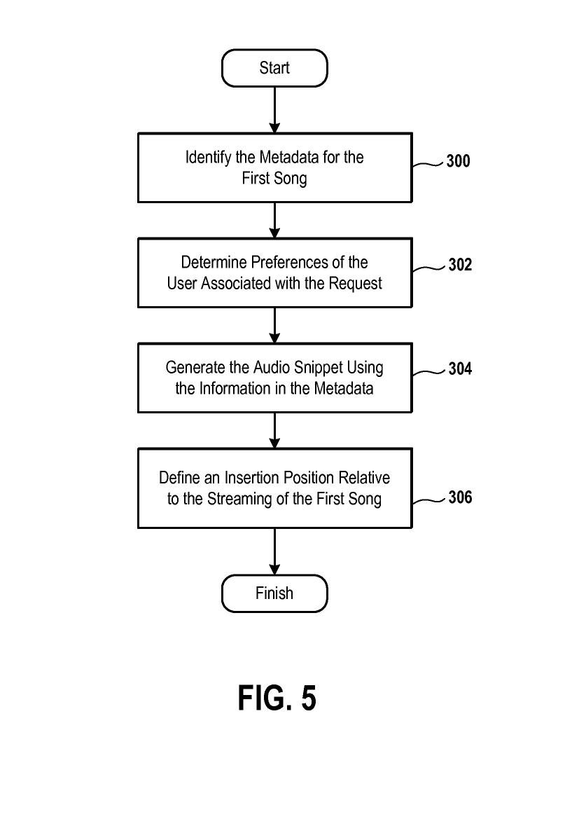

FIG. 5 is a flowchart diagram illustrating in more detail the method operations performed in connection with the identification of an audio snippet to be associated with the first song, in accordance with an example embodiment. In operation 300, the metadata for the first song is identified. In operation 302, the preferences of the user associated with the request for streaming audio are determined. This operation might be performed by checking the preferences of the user set forth in the user's account with the music streaming service. In operation 304, the audio snippet is generated using the information in the metadata. By way of example, the audio snippet can be generated using a text-to-voice service or by recording a person reading the information in the metadata. In a case in which the user prefers just the basic information regarding a song, e.g., artist name and song title, the pertinent metadata is selected from the song file and the selected metadata is processed by a text-to-voice service to generate the audio snippet. In a case in which the user prefers more detailed information regarding a song, the metadata selected from the song file can include any available metadata that describes information beyond the artist name and song title. In either case, the audio snippet also could be generated in advance by recording a person reading the desired metadata. The audio snippet generated either by the text-to-voice service or by recording a person can be stored as an audio file in any suitable format, e.g., mp3.

The method continues in operation 306, in which an insertion position relative to the streaming of the first song is defined for the audio snippet. This operation might be performed by logic that takes a number of factors into consideration including, for example, the preferences of the user, the default settings, and the context of the streaming music. In a case in which the audio snippet is to be inserted before the first song is played, the stream can be paused for a brief period, e.g., one to two seconds, before the first song is to be played back. Once the stream is paused, the audio snippet can be announced aloud and then, after another brief pause, the first song can be played back. In a case in which the audio snippet is to be inserted after the first song has been played back, the stream can be paused for a brief period after the first song has been played back. Once the stream is paused, the audio snippet can be announced aloud and then, after another brief pause, streaming can be resumed so that a second song in the stream can be played back.

In another example, the audio snippet might be inserted into the stream during playback of the first song. In this example, the playback volume could be lowered as playback of the first song begins, and the audio snippet could be announced over the playback of the first song. After the announcement, the playback volume could be brought back up to the original level for playback of the remainder of the first song.

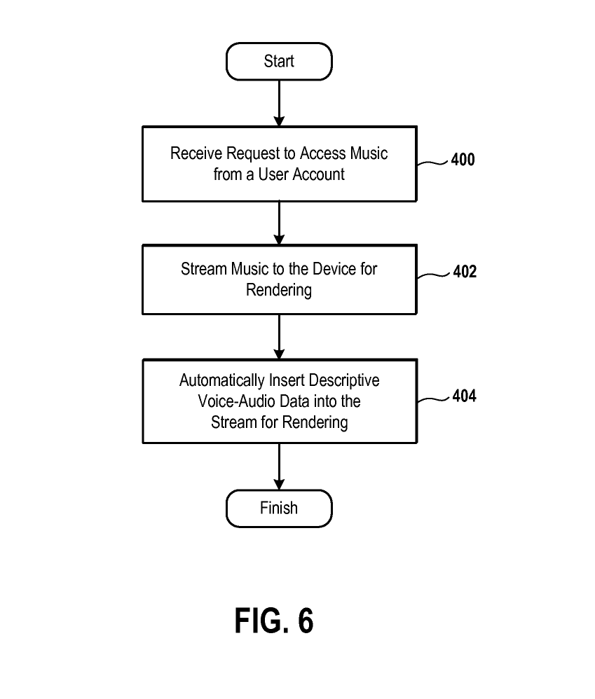

FIG. 6 is a flowchart diagram illustrating the method operations performed in providing automated audio announcements in streaming music, in accordance with an example embodiment. In operation 400, a request to access music is received from a user account. The music is to be streamed to a device from which the user account has generated the request, e.g., a smartphone, tablet computer, etc. In operation 402, music is streamed to the device for rendering. In operation 404, descriptive voice-audio data is automatically inserted into the stream for rendering. The descriptive voice-audio data includes information regarding the music, e.g., artist name, song title, etc.

In an example embodiment, the descriptive voice-audio data is automatically inserted into the stream of music in response to a voice command received from the user account. In one example, the voice command received from the user account might request basic information regarding a song using the phrase “What song is this?” In another example, the voice command might request more detailed information regarding a song using the phrase “Tell me more about this song.” In response to the voice command, the requested voice-audio data is inserted into the stream for rendering by the device. By way of example, the voice-audio data might be contained in a prerecorded audio file or might be generated by performing text-to-voice processing on the metadata for a song.

In a case in which the descriptive voice-audio data is contained in a prerecorded audio file, in response to the voice command, the prerecorded audio file associated with the song is accessed. In one example, the prerecorded audio file is accessed in a database in which the audio file is stored. Thereafter, the prerecorded audio file is inserted into the stream for rendering.

In a case in which the descriptive voice-audio data is generated by performing text-to-voice processing, the metadata for the song is examined to identify the part(s) that will be used. If the request is for basic information regarding a song, then the metadata indicating the artist name and the song title might be used. If the request is for more detailed information regarding a song, then additional metadata that provides information beyond the artist name and the song title also might be used. Next, text-to-voice processing is performed on the selected part(s) of the metadata for the song to generate an audio file containing the descriptive voice-audio data. The generated audio file is associated with the song and is inserted into the stream for rendering.

In one example, the descriptive voice-audio data might be inserted into the stream so as to introduce a song. Thus, before a song, the resulting automated announcement might say “Up next [song title] by [artist].” For example, “Up next “Satisfaction” by the Rolling Stones.” In another example, the descriptive voice-audio data might be inserted into the stream so as to close out a song. Thus, after a song, the resulting automated announcement might say “That was [song title] by [artist].” For example, “That was “Satisfaction” by the Rolling Stones.”

In the case where the descriptive voice-audio data is inserted into the stream in response to a voice command, the voice-audio data will be inserted into the stream during a song. In this scenario, the playback volume of the song playing might be lowered to enable the automated announcement to be made over the song. After the announcement has been made, the framework could bring the playback volume back up to the original (normal) level. In another example, the framework could pause the playback of the song and then make the automated announcement. After the announcement has been made, the framework could resume playback of the song.

The techniques described herein enable automated audio announcements of song information to be made during the streaming of music. These techniques provide a hands-free and eyes-free way to facilitate music discovery. This helps music streaming services to provide a more useful and valuable service to users.

Some portions of the disclosure describe algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like.

Furthermore, it is also convenient at times, to refer to certain arrangements of steps requiring physical manipulations of physical quantities as modules or code devices, without loss of generality. It should be borne in mind, however, that all of these and similar terms are to be associated with the appropriate physical quantities and are merely convenient labels applied to these quantities. Unless specifically stated otherwise as apparent from the context, descriptions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission, or display devices.

Certain aspects of the example embodiments include process steps and instructions described herein in the form of an algorithm. It should be noted that the process steps and instructions of the example embodiments could be embodied in software, firmware, or hardware, and when embodied in software, could be downloaded to reside on and be operated from different platforms used by a variety of operating systems. Some example embodiments also relate to an apparatus for performing the operations described in the disclosure. This apparatus might be specially constructed for the required purposes, or it may comprise a general-purpose computer selectively activated or reconfigured by a computer program stored in the computer. Such a computer program might be stored in a computer-readable storage medium, such as, but is not limited to, any type of disk including floppy disks, optical disks, CO-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions.

Furthermore, one or more of computers referred to in the disclosure might include a single processor or might be architectures employing multiple processor designs for increased computing capability. The algorithms and/or displays described in the disclosure are not inherently related to any particular computer or other apparatus. Various general-purpose systems may also be used with programs in accordance with the teachings described in the disclosure, or it might prove convenient to construct more specialized apparatuses to perform the described method steps.

In addition, the example embodiments in the disclosure are not described with reference to any particular programming language. It will be appreciated that a variety of programming languages might be used to implement the example embodiments.

Accordingly, the disclosure of the example embodiments is intended to be illustrative, but not limiting, of the scope of the disclosures, which are set forth in the following claims and their equivalents. Although example embodiments of the disclosures have been described in some detail for purposes of clarity of understanding, it will be apparent that certain changes and modifications can be practiced within the scope of the following claims. In the following claims, elements and/or steps do not imply any particular order of operation, unless explicitly stated in the claims or implicitly required by the disclosure.

What is claimed is:

1. A method, comprising:
receiving a request to access audio data from a user account, the audio data including a plurality of songs to be streamed to a device from which the user account generated the request;
identifying a first song of the plurality of songs to be streamed to the device;
identifying an audio snippet for the first song, the audio snippet including descriptive voice-audio data regarding the first song; and
streaming the first song and the audio snippet to the device for rendering, the audio snippet being streamed before a second song of the plurality of songs is streamed to the device for rendering, wherein the method is executed by a processor.

2. The method of claim 1, wherein the identifying of the audio snippet for the first song includes:
accessing a music repository that includes a database of songs, the first song being included in the database of songs and being associated with an audio snippet, wherein the audio snippet is a prerecorded audio file.

3. The method of claim 1, wherein the identifying of the audio snippet for the first song includes:
examining metadata for the first song;
identifying preferences associated with the user account;
generating the audio snippet using at least part of the metadata for the first song; and
associating the audio snippet with the first song.

4. The method of claim 3, wherein the generating of the audio snippet includes performing text-to-voice processing on at least part of the metadata for the first song.

5. The method of claim 1, further comprising:
processing insertion logic to determine a placement of the audio snippet relative to the first song, the placement being before, after, or during the first song, and the insertion logic providing for a transition between the first song and the audio snippet.

6. The method of claim 5, wherein the placement of the audio snippet is during the first song, and the insertion logic provides for the transition by causing a volume at which the first song is being rendered to be lowered.

7. The method of claim 1, wherein the descriptive voice-audio data introduces the first song or closes out the first song.

8. The method of claim 7, wherein the descriptive voice-audio data includes an artist name and a song title.

9. A method, comprising:
receiving a request to access a playlist from a user account, the playlist including a plurality of songs to be streamed to a device from which the user account generated the request;
identifying a song in the playlist to be streamed to the device;
accessing an audio snippet associated with the song, the audio snippet being descriptive voice-audio data regarding the song; and
streaming the song and the audio snippet to the device for rendering, the audio snippet being streamed before another song in the playlist is streamed to the device for rendering, wherein the method is executed by a processor.

10. The method of claim 9, wherein the audio snippet associated with the song is a prerecorded audio file.

11. The method of claim 9, wherein the audio snippet associated with the song is generated by performing text-to-voice processing on at least part of the metadata for the song.

12. The method of claim 9, wherein the audio snippet introduces the song by providing an artist name and a song title.

13. The method of claim 9, wherein the audio snippet closes out the song by providing an artist name and a song title.

14. A method, comprising:
receiving a request to access music from a user account, the music to be streamed to a device from which the user account generated the request;
streaming music to the device for rendering; and
automatically inserting descriptive voice-audio data into the stream for rendering, the descriptive voice-audio data including information regarding the music, wherein the method is executed by a processor.

15. The method of claim 14, wherein automatically inserting the descriptive voice-audio data into the stream for rendering includes:
receiving a voice command from the user account for information regarding a song;
accessing a prerecorded audio file associated with the song; and
inserting the prerecorded audio file into the stream for rendering.

16. The method of claim 14, wherein automatically inserting the descriptive voice-audio data into the stream for rendering includes:
receiving a voice command from the user account for information regarding a song;
examining metadata for the song;
performing text-to-voice processing on at least part of the metadata for the song to generate an audio file containing descriptive voice-audio data and associating the audio file with the song; and
inserting the audio file into the stream for rendering.

17. The method of claim 14, wherein the descriptive voice-audio data is inserted into the stream so as to introduce a song.

18. The method of claim 14, wherein the descriptive voice-audio data is inserted into the stream so as to close out a song.

19. The method of claim 14, wherein the descriptive voice-audio data includes an artist name and a song title.

20. One or more non-transitory computer-readable storage devices storing a program which, when executed, instructs a processor perform the following operations:
receive a request to access music from a user account, the music to be streamed to a device from which the user account generated the request;
stream music to the device for rendering; and
automatically insert descriptive voice-audio data into the stream for rendering, the descriptive voice-audio data including information regarding the music.

21. The computer-readable storage device of claim 20, wherein, in connection with the automatic insertion of the descriptive voice-audio data into the stream for rendering, the program further instructs the processor to perform the following operations:
receive a voice command from the user account for information regarding a song;
access a prerecorded audio file associated with the song; and
insert the prerecorded audio file into the stream for rendering.

22. The computer-readable storage device of claim 20, wherein, in connection with the automatic insertion of the descriptive voice-audio data into the stream for rendering, the program further instructs the processor to perform the following operations:
receive a voice command from the user account for information regarding a song;
examine metadata for the song;
perform text-to-voice processing on at least part of the metadata for the song to generate an audio file containing descriptive voice-audio data and associating the audio file with the song; and
insert the audio file into the stream for rendering.

23. The computer-readable storage device of claim 20, wherein the descriptive voice-audio data is inserted into the stream so as to introduce a song.

24. The computer-readable storage device of claim 20, wherein the descriptive voice-audio data is inserted into the stream so as to close out a song.

25. The computer-readable storage device of claim 20, wherein the descriptive voice-audio data includes an artist name and a song title.
